(19) United States
(12) Patent Application Publication
(10) Pub. No.: US 2025/0163332 A1
(43) Pub. Date: May 22, 2025

(54) METHOD FOR REMOVING CHLORINE FROM WASTE PLASTIC PYROLYSIS OIL

(71) Applicants: SK INNOVATION CO., LTD., Seoul (KR); SK GEO CENTRIC CO., LTD., Seoul (KR)

(72) Inventors: Heejung JEON, Daejeon (KR); Okyoun KIM, Daejeon (KR); Kayoung KIM, Daejeon (KR); Gyutae PARK, Daejeon (KR); Youngmoo PARK, Daejeon (KR); Jaehwan LEE, Daejeon (KR)

(21) Appl. No.: 18/841,676

(22) PCT Filed: Mar. 7, 2023
(86) PCT No.: PCT/KR2023/003121

§ 371 Date: Aug. 27, 2024

(30) Foreign Application Priority Data
Mar. 7, 2022 (KR) 10-2022-0028536

(51) Int. Cl. C10G 1/10; C10G 1/00; C10G 53/04

(52) U.S. Cl. CPC C10G 1/10; C10G 1/004; C10G 53/04; C10G 2300/1003; C10G 2300/202; C10G 2300/4006; C10G 2300/4012; C10G 2300/44

(57) ABSTRACT

The present disclosure relates to a method for removing chlorine from waste plastic pyrolysis oil, the method including: (S1) mixing and reacting waste plastic pyrolysis oil with a neutralizing solution that contains a neutralizer containing M-OR₁ and a solvent; and (S2) subjecting a fluid generated in the step (S1) to a water treatment to remove chlorine, wherein M is an alkali metal or an alkaline earth metal, and R₁ is a C₁ to C₁₀ alkyl group.

### CROSS-REFERENCES TO RELATED APPLICATION

The present application is a national stage entry of PCT/KR2023/003121, filed on Mar. 7, 2023, and claims priority under 35 U.S.C. § 119(a) to Korean Patent Application Number 10-2022-0028536, filed on Mar. 7, 2022, which is incorporated herein by reference in its entirety.

### BACKGROUND

### Technical Field

Embodiments of the present disclosure generally relate to a method for removing chlorine from waste plastic pyrolysis oil.

### Related Art

Waste plastics, which are produced using petroleum as a raw material, are not recyclable and are mostly disposed of as garbage. These wastes take a long time to degrade in nature, causing contamination of the soil and serious environmental pollution. As a method for recycling waste plastics, waste plastics may be pyrolyzed and converted into usable oil, which is called waste plastic pyrolysis oil.

However, pyrolysis oil obtained by pyrolyzing waste plastics may not be immediately used as a high-value-added fuel such as gasoline or diesel oil because it has a higher content of impurities such as chlorine, nitrogen, and metals compared to fractions produced from crude oil by a general method, and therefore, pyrolysis oil needs to go through a refinery process.

In the refinery process according to the related art, chlorine has been converted to HCl and removed by hydrotreating in the presence of a hydrotreating catalyst. However, since waste plastic pyrolysis oil contains a high content of chlorine, an excessive amount of HCl is generated during hydrotreating, and equipment corrosion, an abnormal reaction, and deterioration of product properties occur. In addition, HCl reacts with a nitrogen compound to produce an ammonium salt (NH₄Cl), and the ammonium salt causes corrosion of a reactor, which causes not only a reduction in durability but also a lot of process issues such as a differential pressure and a reduction in process efficiency.

Conventional art includes a method for producing gasoline, diesel engine oil, and carbon black using waste rubber and/or waste plastics. Chlorine, nitrogen, sulfur, and the like are removed using basic substances such as KOH and NaOH in a primary impurity removal process of pyrolysis oil obtained by pyrolyzing waste rubber and waste plastics, and cracked oil is separated in a secondary catalytic cracking process, thereby producing a final product. In the primary impurity removal process, chlorine is reduced by a neutralization process using basic substances such as KOH and NaOH. However, such a neutralization and removal reaction does not have a high chlorine removal efficiency per unit weight of basic substance, which makes it difficult to produce oil having a minimized content of chlorine (a few ppm of Cl) to a level that may be introduced into the refinery process, and a strong base neutralizer such as NaOH causes equipment corrosion, which causes various process complications such as an abnormal reaction and a reduction in process efficiency.

In addition, as a method for reducing chlorine in waste plastic pyrolysis oil according to the related art, a cleaning process or a water treatment process has been performed. However, in the case of such a process, only inorganic chlorine is mainly removed from pyrolysis oil, and organic chlorine is mostly not removed.

Therefore, there is a demand for a technique that may reduce both organic chlorine and inorganic chlorine to a level of a few ppm so that waste plastic pyrolysis oil containing a high content of chlorine may be introduced into a refinery process, and may minimize issues such as equipment corrosion, an abnormal reaction, and deterioration of product properties.

### SUMMARY

The embodiments of the present disclosure provide a method and apparatus for removing chlorine from waste plastic pyrolysis oil that may effectively remove organic chlorine by converting organic chlorine in waste plastic pyrolysis oil into inorganic chlorine and may maximize chlorine removal efficiency in conjunction with a subsequent desalter process.

The embodiments of the present disclosure also provide a method and apparatus for removing chlorine from waste plastic pyrolysis oil that may implement improvement of process stability by minimizing corrosion of a reactor in a process of removing chlorine.

The embodiments of the present disclosure further provide a method and apparatus for removing chlorine from waste plastic pyrolysis oil that may implement a stable operation for a long period of time by suppressing or minimizing formation of an ammonium salt (NH₄Cl) during hydrotreating in a subsequent refinery process through removal of chlorine from waste plastic pyrolysis oil to a level of a few ppm.

In an embodiment of the present disclosure, a method for removing chlorine from waste plastic pyrolysis oil includes (S1) mixing and reacting waste plastic pyrolysis oil with a neutralizing solution that contains a neutralizer containing M-OR₁ and a solvent; and (S2) subjecting a fluid generated in the operation (S1) to a water treatment to remove chlorine, wherein M is an alkali metal or an alkaline earth metal, and R₁ is a C₁ to C₁₀ alkyl group.

In an embodiment of the present disclosure, the operation (S1) may be performed at a temperature of 300 to 500° C.

In an embodiment of the present disclosure, in the operation (S1), M-OR₁ may contain Na—OR₂.

In an embodiment of the present disclosure, in the operation (S1), the solvent may contain an alcohol.

In an embodiment of the present disclosure, the alcohol may have a molecular weight of 25 to 800 g/mol and a density of 0.5 to 1.1 g/cm³.

In an embodiment of the present disclosure, a difference in density between the waste plastic pyrolysis oil and the alcohol may be 0.3 g/cm³ or less.

In an embodiment of the present disclosure, in the operation (S1), the solvent may further contain water.

In an embodiment of the present disclosure, in the operation (S1), the waste plastic pyrolysis oil, the neutralizing solution, and an inorganic bead catalyst may be added to a batch reactor to perform a reaction.

In an embodiment of the present disclosure, the operation (S1) may be performed by passing the waste plastic pyrolysis oil and the neutralizing solution through a fixed bed reactor filled with an inorganic bead catalyst.

In an embodiment of the present disclosure, the operation (S2) may be performed at 30 to 250° C. and 2 to 50 bar.

In an embodiment of the present disclosure, the operation (S2) may be performed by supplying washing water to the fluid generated in the operation (S1), washing the fluid with water, and discharging an aqueous solution containing chlorine.

In an embodiment of the present disclosure, 90% or more of the chlorine in the waste plastic pyrolysis oil may be removed through the operations (S1) and (S2).

In another embodiment, an apparatus for removing chlorine from waste plastic pyrolysis oil includes a mixer into which a neutralizer containing M-OR₁ and a solvent are introduced and in which the neutralizer containing M-OR₁ and the solvent are mixed with each other;
a reactor into which a neutralizing solution generated in the mixer and waste plastic pyrolysis oil are introduced and in which the neutralizing solution and the waste plastic pyrolysis oil react with each other; and
a desalter into which a fluid generated in the reactor and washing water are introduced, in which impurities in the fluid are washed with water, and from which an aqueous solution containing chlorine is discharged,
wherein M is an alkali metal or an alkaline earth metal, and R₁ is a C₁ to C₁₀ alkyl group.

In an embodiment of the present disclosure, a temperature of the reactor may be 300 to 500° C.

In an embodiment of the present disclosure, the reactor may be a batch reactor, and an inorganic bead catalyst may be introduced into the reactor.

In an embodiment of the present disclosure, the reactor may be a fixed bed reactor filled with an inorganic bead catalyst.

In an embodiment of the present disclosure, the desalter may further include an electric field application unit.

In an embodiment of the present disclosure, the desalter may further include a plurality of outlets, and the outlet may further include a density profiler.

In an embodiment of the present disclosure, a temperature of the desalter may be 30 to 250° C., and a pressure of the desalter may be 2 to 50 bar.

### Advantageous Effects

As set forth above, in the method and apparatus for removing chlorine from waste plastic pyrolysis oil, organic chlorine in the waste plastic pyrolysis oil is converted into inorganic chlorine, such that the organic chlorine may be effectively removed, and the chlorine removal efficiency may be maximized in conjunction with a subsequent desalter process.

In the method and apparatus for removing chlorine from waste plastic pyrolysis oil according to the embodiments of the present disclosure, corrosion of the reactor is minimized during removal of chlorine, such that the process stability may be improved.

In the method and apparatus for removing chlorine from waste plastic pyrolysis oil according to the embodiments of the present disclosure, chlorine in waste plastic pyrolysis oil is removed to a level of a few ppm, such that formation of an ammonium salt (NH₄Cl) may be suppressed or minimized during hydrotreating in a subsequent refinery process, and a stable operation for a long period of time may be implemented.

### BRIEF DESCRIPTION OF DRAWINGS

FIG. 1 illustrates a process of refining waste plastic pyrolysis oil using an alcohol solvent according to an embodiment of the present disclosure.

FIG. 2 illustrates a process of refining waste plastic pyrolysis oil using a cosolvent containing an alcohol and water according to an embodiment of the present disclosure.

### DETAILED DESCRIPTION

The embodiments described in the present specification are provided by way of example so that the spirit of the present disclosure can be sufficiently transferred to those skilled in the art. Therefore, the present disclosure is not limited to the embodiments disclosed, and may be implemented in other forms. In addition, the drawings described in the present specification may be exaggerated to clearly conform with the scope of the present disclosure.

Unless otherwise defined, all the technical terms and scientific terms used in the present specification have the same meanings as commonly understood by those skilled in the art to which the present disclosure pertains. The description for known functions and configurations which unnecessarily obscure the gist of the present disclosure will be omitted in the following description and the accompanying drawings.

Unless the context clearly indicates otherwise, the singular forms of the terms used in the present specification may be interpreted as including the plural forms.

A numerical range used in the present specification includes upper and lower limits and all values within these limits, increments logically derived from a form and span of a defined range, all double limited values, and all possible combinations of the upper and lower limits in the numerical range defined in different forms. Unless otherwise specifically defined in the present specification, values out of the numerical ranges that may occur due to experimental errors or rounded values also fall within the defined numerical ranges.

The expression “comprises(s)” described in the present specification is intended to be an open-ended transitional phrase having an equivalent meaning to “include(s)”, “contain(s)”, “have (has)”, or “are (is) characterized by”, and does not exclude elements, materials, or operations, all of which are not further recited herein.

Unless otherwise defined, a unit of “%” used in the present specification unless specifically mentioned refers to “wt %”.

Unless otherwise defined, a unit of “ppm” used in the present specification unless specifically mentioned refers to “mass ppm”.

Unless otherwise defined, a boiling point used in the present specification refers to a boiling point at 1 atm.

Unless otherwise defined, a density used in the present specification refers to a density at room temperature (25° C.).

Unless otherwise defined, in M-OR₁ used in the present specification, M represents an alkali metal or an alkaline earth metal, and R₁ represents a C₁ to C₁₀ alkyl group.

The alkali metal or the alkaline earth metal refers to a metal commonly used in the art. Examples of the alkali metal include lithium (Li), sodium (Na), potassium (K), rubidium (Rb), cesium (Cs), and francium (Fr), and examples of the alkaline earth metal include beryllium (Be), magnesium (Mg), calcium (Ca), strontium (Sr), barium (Ba), and radium (Ra).

Organic chlorine described in the present specification refers to chlorine combined with an organic compound or an organic polymer.

In the refinery process of waste plastic pyrolysis oil according to the related art, chlorine has been converted to HCl and removed by hydrotreating in the presence of a hydrotreating catalyst. However, since waste plastic pyrolysis oil contains a high content of chlorine, an excessive amount of HCl is generated during hydrotreating, and equipment corrosion, an abnormal reaction, and deterioration of product properties occur. In addition, HCl reacts with a nitrogen compound to produce an ammonium salt (NH₄Cl), and the ammonium salt causes corrosion of a reactor, which causes not only a reduction in durability but also a lot of process problems such as a differential pressure and a reduction in process efficiency.

In addition, in the related art, a technique has been carried out, in which chlorine, nitrogen, sulfur, and the like are removed using basic substances such as KOH and NaOH in a primary impurity removal process of pyrolysis oil obtained by pyrolyzing waste rubber and waste plastics, and cracked oil is separated in a secondary catalytic cracking process, thereby producing a final product. However, such a neutralization and removal reaction does not have a high chlorine removal efficiency per unit weight of basic substance, which makes it difficult to produce oil having a low content of chlorine to a level that may be introduced into the refinery process, and a strong base neutralizer such as NaOH causes equipment corrosion, which causes various process problems such as an abnormal reaction and a reduction in process efficiency.

In a method for reducing chlorine in waste plastic pyrolysis oil, a cleaning process or a water treatment process has been performed. However, in the case of such a process, only inorganic chlorine is mainly removed from pyrolysis oil, and organic chlorine is mostly not removed.

Accordingly, embodiments of the present disclosure provide a method for removing chlorine from waste plastic pyrolysis oil, the method including (S1) mixing and reacting waste plastic pyrolysis oil with a neutralizing solution that contains a neutralizer containing M-OR₁ and a solvent, where M is an alkali metal or an alkaline earth metal, and R₁ is a C₁ to C₁₀ alkyl group; and (S2) subjecting a fluid generated in the operation (S1) to a water treatment to remove chlorine.

The waste plastic pyrolysis oil may be a mixture of hydrocarbon oils produced by pyrolyzing waste plastics at a high temperature. In this case, the waste plastics may include solid or liquid waste related to synthetic polymer compounds such as a waste synthetic resin, a waste synthetic fiber, waste synthetic rubber, and waste vinyl.

The mixture of hydrocarbon oils may contain impurities such as a chlorine compound, a nitrogen compound, and a metal compound in addition to hydrocarbon oil, and both organic chlorine and inorganic chlorine may be present in the chlorine compound. In addition, the mixture of hydrocarbon oils may contain impurities in the form of metal-binding compounds and may contain hydrocarbons in the form of olefins.

A content of the chlorine compound in the waste plastic pyrolysis oil may be 50 ppm or more, and specifically, may be 100 ppm or more. An upper limit of a content of the chlorine is not particularly limited, and may be, for example, 1,000 ppm or less, and specifically, 800 ppm or less.

A weight ratio of the organic chlorine and the inorganic chlorine contained in the chlorine compound may be 100:0 to 800, and specifically, may be 100:30 to 60, but this weight ratio is only an example and the embodiments are not limited thereto.

In the operation (S1) of mixing and reacting the waste plastic pyrolysis oil with the neutralizing solution that contains the neutralizer containing M-OR₁ and the solvent, organic chlorine in the waste plastic pyrolysis oil may be converted into inorganic chlorine, and the converted inorganic chlorine may be trapped in the neutralizing solution that contains the neutralizer and the solvent.

In an embodiment of the present disclosure, the operation (S1) may be performed at a temperature of 300 to 500° C. In a case where the waste plastic pyrolysis oil is treated at a high temperature of 300° C. or higher, the organic chlorine in the pyrolysis oil may be converted into inorganic chlorine, for example, HCl (hereinafter, HCl refers to inorganic chlorine). Since the organic chlorine forms a significantly strong bond with hydrocarbon residues, when the operation (S1) is performed at 300° C. or lower, the efficiency of converting the organic chlorine into HCl is low, and when the operation (S1) is performed at 500° C. or higher, a side reaction of cracking of the pyrolysis oil occurs, which may cause catalyst deactivation and yield loss. Specifically, the temperature may be 350 to 450° C., and more specifically, may be 370 to 420° C.

The neutralizer containing M-OR₁ reacts with HCl in the pyrolysis oil to generate NaCl, such that chlorine may be trapped from the pyrolysis oil and R₁—OH may be generated as a by-product. In the related art, a strong base neutralizer such as NaOH, KOH, Mg(OH)₂, or Ca(OH)₂ has been used as a neutralizer for removing chlorine. However, such a strong base neutralizer causes corrosion of the reactor, resulting in a problem of reducing reaction stability and a fatal problem of reducing process efficiency. In a case where the neutralizer containing M-OR₁ is used, the corrosion of the reactor may be suppressed, and R₁—OH that is a by-product reacts with an organic acid in the pyrolysis oil, such that a total acid number (TAN) may be reduced.

In an embodiment of the present disclosure, in the operation (S1), M-OR₁ may contain Na—OR₂ (R₂ is a C₁ to C₄ alkyl group). It may be preferable to use a Na—OR₂ neutralizer containing a sodium (Na) metal and a C₁ to C₄ alkyl group in terms of solubility and reactivity with HCl.

The neutralizer containing M-OR₁ may be contained in an amount of 0.05 to 5 parts by weight with respect to 100 parts by weight of the waste plastic pyrolysis oil. When the above range is satisfied, the chlorine compound in the waste plastic pyrolysis oil may be efficiently trapped. Specifically, the neutralizer containing M-OR₁ may be contained in an amount of, specifically, 0.1 to 3 parts by weight, and more specifically, 0.2 to 1 part by weight.

The waste plastic pyrolysis oil is mixed with the neutralizing solution that contains the neutralizer containing M-OR₁ and the solvent, such that the neutralizer containing M-OR₁ may be more easily introduced into the waste plastic pyrolysis oil. In a case where the neutralizer containing M-OR₁ is directly introduced into the waste plastic pyrolysis oil in a solvent-free form, the neutralizer is not easily mixed with the pyrolysis oil and agglomeration may occur. Therefore, the neutralizer containing M-OR₁ may be mixed with the pyrolysis oil in the form of a neutralizing solution to more easily introduce the neutralizer into the pyrolysis oil.

In an embodiment of the present disclosure, in the operation (S1), the solvent may contain an alcohol. An alcohol solvent is a solvent that may easily dissolve M-OR₁, and has a significantly high solubility of M-OR₁ and NaCl, which is advantageous in terms of mixing the waste plastic pyrolysis oil and the neutralizer. Specifically, the alcohol solvent may include a mixture of one or more selected from ethanol, propanol, isopropanol, butanol, 2-ethylhexyl alcohol, butylene glycol, neopentyl glycol, dipropylene glycol, and tripropylene glycol, but this is only an example, and any alcohol may be used in various ways without limitation as long as it is an alcohol having high solubility of an M-OR₁ neutralizer.

A boiling point of the alcohol may be 70° C. or higher. Using an alcohol having a boiling point of 70° C. or higher may be advantageous in terms of operation stability. Specifically, the boiling point may be 90° C. or higher, and more specifically, the boiling point may be 110° C. or higher. The boiling point may be 300° C. or lower without limitation.

In an embodiment of the present disclosure, the alcohol may have a molecular weight of 25 to 800 g/mol and a density of 0.5 to 1.1 g/cm³. When the molecular weight and density ranges are satisfied, it may be advantageous in terms of mixing the waste plastic pyrolysis oil and the neutralizing solution. Specifically, the molecular weight may be 45 to 500 g/mol and the density may be 0.7 to 1.1 g/cm³, and more specifically, the molecular weight may be 45 to 300 g/mol and the density may be 0.7 to 0.9 g/cm³.

In an embodiment of the present disclosure, a difference in density between the waste plastic pyrolysis oil and the alcohol may be 0.3 g/cm³ or less. When the difference in density is 0.3 g/cm³ or less, the waste plastic pyrolysis oil and the alcohol may be more easily mixed with each other, and when the difference in density is 0.3 g/cm³ or more, layer separation may occur due to the difference in density between the waste plastic pyrolysis oil and the alcohol. Specifically, the difference in density may be 0.2 g/cm³ or less, and more specifically, may be 0.1 g/cm³ or less. The difference in density may be 0 or more or 0.01 g/cm³ or more without limitation.

In an embodiment of the present disclosure, the solvent may further contain water. Water may effectively trap HCl because it has high solubility of HCl, and the solvent further contains water together with the alcohol, such that chlorine in the waste plastic pyrolysis oil may be effectively removed. The neutralizer containing M-OR₁ is dissolved in a cosolvent containing water and an alcohol, such that the solubility of HCl and NaCl in the cosolvent may be increased.

Accordingly, it may be preferable in that the organic chlorine is converted into HCl, and then HCl is rapidly converted into NaCl by the neutralizer containing M-OR₁, such that the corrosion of the reactor may be suppressed, and the generated NaCl is not precipitated in the solvent but is dissolved in the cosolvent and may be completely removed from the waste plastic pyrolysis oil by subsequent oil-water separation.

In the case where the solvent further contains water, the solvent may be contained in an amount of 5 to 50 parts by weight with respect to 100 parts by weight of the waste plastic pyrolysis oil. When the above range is satisfied, HCl in the waste plastic pyrolysis oil may be efficiently trapped. Specifically, the solvent may be contained in an amount of, specifically, 5 to 40 parts by weight, and more specifically, 5 to 30 parts by weight. In addition, in the case where the solvent further contains water, a weight ratio of the water and the alcohol in the cosolvent may be 100:5 to 100:50, and specifically, may be 100:5 to 100:30.

In the case where the solvent further contains water, the operation (S1) may be performed at a temperature of 300 to 500° C. When water is used as a solvent at a high temperature of 300° C. or higher, recombination of HCl in the waste plastic pyrolysis oil with olefins may be effectively prevented. Specifically, the temperature may be 330 to 400° C., and more specifically, may be 350 to 380° C.

In an embodiment of the present disclosure, in the operation (S1), the waste plastic pyrolysis oil, the neutralizing solution, and an inorganic bead catalyst may be added to a batch reactor to perform a reaction. By adding the inorganic bead catalyst to the reactor, reaction heat may be dissipated, and the waste plastic pyrolysis oil and the neutralizing solution may be more easily mixed with each other, and a side reaction may be suppressed to improve reaction efficiency. The reaction may be performed in an inert atmosphere, for example, a nitrogen atmosphere, and the reaction may be performed under conditions of a temperature of 350 to 500° C., a pressure of 5 to 50 bar, a time of 1 to 15 hours, and a stirring speed of 100 to 4,000 rpm. Specifically, the reaction may be performed under conditions of a temperature of 350 to 500° C., a pressure of 5 to 25 bar, a time of 1 to 10 hours, and a stirring speed of 100 to 2,000 rpm, but this is only an example, and the embodiments are not limited thereto.

In an embodiment of the present disclosure, the operation (S1) may be performed by passing the waste plastic pyrolysis oil and the neutralizing solution through a fixed bed reactor filled with an inorganic bead catalyst. The fixed bed reactor has an advantage of high productivity and may be operated in a continuous mode. After the waste plastic pyrolysis oil and the neutralizing solution that contains the neutralizer containing M-OR₁ and the solvent are added to the fixed bed reactor filled with the inorganic bead catalyst, the reaction may be performed by controlling various reaction conditions for controlling reaction activity.

The reaction is performed in the presence of the inorganic bead catalyst, such that the waste plastic pyrolysis oil and the neutralizing solution may be more easily mixed with each other. As turbulence is formed in a packed bed filled with the inorganic bead catalyst, the reaction efficiency may be improved.

In an embodiment of the present disclosure, when the solvent is a cosolvent that further contains water, the miscibility of the waste plastic pyrolysis oil and the cosolvent may be slightly lower than that of a solvent containing only an alcohol, such that a conversion rate of HCl removed from the waste plastic pyrolysis oil into NaCl may be low. However, as the fixed bed reactor is used, although the miscibility is somewhat reduced, active material exchange occurs between the waste plastic pyrolysis oil and the cosolvent due to the turbulence generated in the packed bed, such that HCl is quickly dissolved in the cosolvent and then converted into NaCl. Therefore, the fixed bed reactor may provide preferred advantages for the cosolvent.

The reaction may be performed in an inert atmosphere, for example, a nitrogen atmosphere, and the reaction may be performed at a temperature of 350 to 500° C., a pressure of 5 to 100 bar, a liquid hourly space velocity (LHSV) of 0.1 to 10 h⁻¹, and a N₂/Oil ratio of 50 to 2,000. Specifically, the reaction may be performed at a temperature of 350 to 450° C., a pressure of 5 to 50 bar, a liquid hourly space velocity (LHSV) of 0.1 to 5 h⁻¹, and a N₂/Oil ratio of 50 to 1,000, but this is an example and the embodiments are not limited thereto.

The inorganic bead catalyst may be one or two or more catalysts selected from silica, alumina, and titania. When the inorganic beads are in the form of powder, a particle size thereof is not particularly limited, and may be typically 500 nm to 10 μm in order to use the inorganic beads as a catalyst. The inorganic beads are preferably silica beads in terms of mixing the waste plastic pyrolysis oil and the neutralizing solution.

In an embodiment of the present disclosure, the operation (S2) may be performed by supplying washing water to the fluid generated in the operation (S1), washing the fluid with water, and discharging an aqueous solution containing chlorine. The waste plastic pyrolysis oil and the neutralizing solution are mixed and reacted with each other in the operation (S1), such that organic chlorine in the waste plastic pyrolysis oil is converted into inorganic chlorine, and the inorganic chlorine is present in the neutralizing solution in the form of NaCl. The washing water is supplied to the fluid containing NaCl, washing is performed with water, and the aqueous solution containing chlorine is discharged, such that chlorine in the waste plastic pyrolysis oil may be removed, and not only NaCl but also remaining organic chlorine and nitrogen may be removed. The washing water may be water or distilled water, but the embodiments are not limited thereto.

Specifically, when the washing water is mixed with the fluid, water-soluble impurities contained in the fluid move to a water layer, and oil-water separation proceeds, and a mixed solution in which the fluid and the washing water are mixed with each other is separated into an oil layer and a water layer. Since the water layer contains an aqueous solution containing chlorine, the oil layer may be recovered immediately or after removal of the water layer, and the water layer may be discharged or recirculated to the operation (S3) after purification.

An electric field may be applied to effectively separate the oil layer and the water layer, and the oil layer and the water layer may be separated in a short time by electrostatic adhesion due to application of the electric field. In addition, an additive may be added as necessary to increase the oil-water separation efficiency, and the additive may be a common demulsifier known in the art.

In an embodiment of the present disclosure, the operation (S2) may be performed at 30 to 250° C. and 2 to 50 bar. Specifically, the operation (S2) may be performed at 30 to 200° C. and 2 to 40 bar, and may be performed in an inert atmosphere, for example, a nitrogen atmosphere. In a case where the water treatment process is performed under the conditions, the oil-water separation efficiency may be improved.

In an embodiment of the present disclosure, 90% or more of the chlorine in the waste plastic pyrolysis oil may be removed through the operations (S1) and (S2). As described above, the organic chlorine in the waste plastic pyrolysis oil is converted into inorganic chlorine to remove the organic chlorine, such that waste plastic pyrolysis oil having chlorine reduced by 90% or more may be obtained. Specifically, the chlorine in the waste plastic pyrolysis oil may be removed by 95% or more, and may be removed by 99% or less without limitation.

In addition, embodiments of the present disclosure provide an apparatus for removing chlorine from waste plastic pyrolysis oil, the apparatus including a mixer into which a neutralizer containing M-OR₁ and a solvent are introduced and in which the neutralizer containing M-OR₁ and the solvent are mixed with each other; a reactor into which a neutralizing solution generated in the mixer and waste plastic pyrolysis oil are introduced and in which the neutralizing solution and the waste plastic pyrolysis oil react with each other; and a desalter into which a fluid generated in the reactor and washing water are introduced, in which impurities in the fluid are washed with water, and from which an aqueous solution containing chlorine is discharged.

A content of the chlorine compound in the waste plastic pyrolysis oil may be 50 ppm or more, and specifically, may be 100 ppm or more. An upper limit of a content of the chlorine is not particularly limited, and may be, for example, 1,000 ppm or less, and specifically, 800 ppm or less. A weight ratio of the organic chlorine and the inorganic chlorine contained in the chlorine compound may be 100:0 to 800, and specifically, may be 100:30 to 60, but this weight ratio is only an example, and the embodiments are not limited thereto.

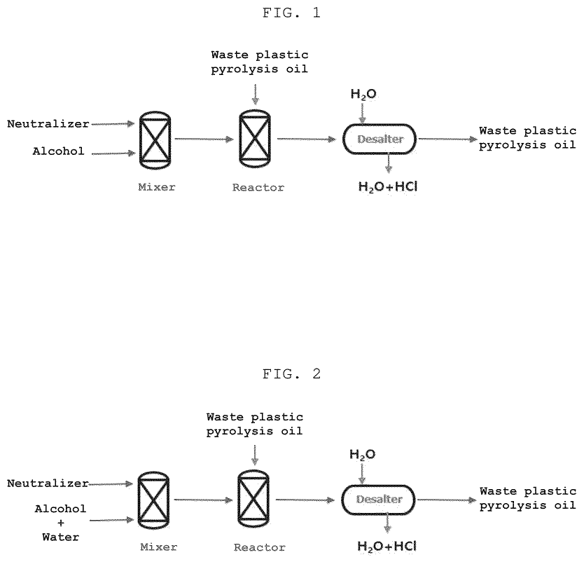

A neutralizer containing M-OR₁ and a solvent may be introduced into the mixer, and the neutralizer containing M-OR₁ and the solvent may be mixed with each other in the mixer. The mixer may include an inlet, each of the neutralizer containing M-OR₁ and the solvent is introduced into the inlet as illustrated in FIGS. 1 and 2, and the order of introduction is not particularly limited. FIG. 1 illustrates a case of using an alcohol solvent, and FIG. 2 illustrates a case of using a cosolvent containing an alcohol and water. The mixing of the neutralizer containing M-OR₁ and the solvent that are introduced into the mixer may be performed in a conventionally known manner, and for example, the neutralizer and the solvent may be uniformly mixed with each other by including a common mixer.

The neutralizing solution generated in the mixer and the waste plastic pyrolysis oil may be introduced into the reactor, organic chlorine in the waste plastic pyrolysis oil may be converted into inorganic chlorine, and the converted inorganic chlorine may be trapped in the neutralizing solution containing the neutralizer and the solvent.

The reactor is connected to the mixer through a first pipe, and the neutralizing solution is introduced from the mixer into the reactor through the first pipe. In this case, the waste plastic pyrolysis oil may be mixed with the neutralizing solution and introduced into the reactor through a second pipe connected to the first pipe. According to another embodiment, the waste plastic pyrolysis oil may be introduced into the reactor through the second pipe connected to the reactor and may react with the neutralizing solution.

The reactor may be a batch reactor or a fixed bed reactor.

In an embodiment of the present disclosure, the reactor may be a batch reactor, and an inorganic bead catalyst may be introduced into the reactor. The reactor further includes an additional inlet, and the inorganic bead catalyst is added through the inlet, such that the waste plastic pyrolysis oil and the neutralizing solution may be more easily mixed with each other, and the reaction efficiency may be improved. The reaction may be performed in an inert atmosphere, for example, a nitrogen atmosphere, and for specific reaction conditions, the contents described in the method for removing chlorine from waste plastic pyrolysis oil described above may be used for reference.

In an embodiment of the present disclosure, the reactor may be a fixed bed reactor filled with an inorganic bead catalyst. The fixed bed reactor has an advantage of high productivity and may be operated in a continuous mode. After the waste plastic pyrolysis oil and the neutralizing solution that contains the neutralizer containing M-OR₁ and the solvent are added to the fixed bed reactor filled with the inorganic bead catalyst through the pipes, the reaction may be performed by controlling various reaction conditions for controlling reaction activity. The reaction is performed in the presence of the inorganic bead catalyst, such that the waste plastic pyrolysis oil and the neutralizing solution may be more easily mixed with each other, and the reaction efficiency may be improved. The reaction may be performed in an inert atmosphere, for example, a nitrogen atmosphere, and for specific reaction conditions, the contents described in the method for removing chlorine from waste plastic pyrolysis oil described above may be used for reference.

In an embodiment of the present disclosure, a temperature of the reactor may be 300 to 500° C. When the temperature of the reactor is 300° C. to 500° C., the organic chlorine in the waste plastic pyrolysis oil may be converted into inorganic chlorine, for example, HCl (hereinafter, HCl refers to inorganic chlorine). Since the organic chlorine forms a significantly strong bond with hydrocarbon residues, when the temperature of the reactor is 300° C. or lower, the efficiency of converting the organic chlorine into HCl is low, and when the reaction is performed at 500° C. or higher, a side reaction of cracking of the pyrolysis oil occurs, which may cause catalyst deactivation and yield loss. Specifically, the temperature may be 350 to 450° C., and more specifically, may be 370 to 420° C.

The neutralizer may contain M-OR₁. The neutralizer reacts with HCl in the pyrolysis oil to generate NaCl, such that chlorine may be trapped from the pyrolysis oil and R₁—OH may be generated as a by-product. In a case where the neutralizer containing M-OR₁ is used, the corrosion of the reactor may be suppressed, and R₁—OH that is a by-product reacts with an organic acid in the pyrolysis oil, such that a total acid number (TAN) may be reduced.

The waste plastic pyrolysis oil and the neutralizing solution that contains the neutralizer containing M-OR₁ and the solvent are mixed with each other in the reactor, such that the neutralizer containing M-OR₁ may be more easily introduced into the waste plastic pyrolysis oil. In a case where the neutralizer containing M-OR₁ is directly introduced into the waste plastic pyrolysis oil without a solvent, a phenomenon in which the neutralizer is not mixed with the pyrolysis oil and aggregates may occur. The neutralizer containing M-OR₁ is dissolved in a solvent to be used in the form of a neutralizing solution, such that the neutralizer may be more easily introduced into the waste plastic pyrolysis oil.

Chlorine compounds may be removed from the waste plastic pyrolysis oil through a desalter into which the fluid generated in the reactor and washing water are introduced and through which an aqueous solution containing chlorine is discharged. A fluid in which the waste plastic pyrolysis oil and the neutralizing solution are mixed with each other is generated in the reactor, the organic chlorine in the pyrolysis oil is converted into inorganic chlorine, and the inorganic chlorine is present in the form of NaCl in the fluid. The fluid containing NaCl and the washing water are introduced into the desalter, the fluid is washed with water in the desalter, and then the aqueous solution containing chlorine is discharged, such that the chlorine in the waste plastic pyrolysis oil may be removed. In addition to NaCl, residual organic chlorine and nitrogen may also be removed.

The desalter is connected to the reactor through a third pipe, and the fluid is introduced from the reactor into the desalter through the third pipe. According to an embodiment, in this case, the washing water may be mixed with the fluid, and the washing water and the fluid may be introduced into the desalter through a fourth pipe connected to the third pipe. According to another embodiment, in this case, after the washing water is introduced into the desalter through the fourth pipe connected to the desalter, the washing water may be mixed with the fluid.

Specifically, after the fluid and the washing water are introduced into the desalter, water-soluble impurities contained in the fluid may move to a water layer by a mixing unit, and subsequently, the mixed solution in which the fluid and the washing water is separated into an oil layer and a water layer. An aqueous solution containing chlorine is contained in the water layer, the oil layer may be recovered through an upper portion of the desalter or may be recovered after removal of the water layer, and the water layer may be discharged out of the system or may be recirculated to the desalter after purification.

The desalter may further include an electric field application unit to apply an electric field to effectively separate the oil layer and the water layer. The oil layer and the water layer may be separated in a short time by electrostatic adhesion due to application of the electric field.

The desalter may include a plurality of outlets attached to positions at different heights. The aqueous solution containing chlorine may be discharged through the outlets. The number of the plurality of outlets may be 2 to 5, and specifically, 2 to 4, but the embodiments are not limited thereto. The plurality of outlets may be attached to a position corresponding to a height of 60% or less of the total height of the desalter. This is usually in consideration of the position where the water layer is formed. Specifically, the plurality of outlets may be attached to a position corresponding to a height of 50% or less of the total height of the desalter and may be attached to a position corresponding to a height of 10 to 40% of the total height of the desalter without limitation, but the embodiments of the present disclosure are not limited thereto.

The outlet included in the desalter may further include a density profiler, and through density detection, it is possible to prevent the oil layer from being removed together with the water layer when the water layer is removed.

In an embodiment of the present disclosure, a temperature of the desalter may be 30 to 250° C., and a pressure of the desalter may be 2 to 50 bar. Specifically, the temperature of the desalter may be 30 to 200° C., the pressure of the desalter may be 2 to 40 bar, and the atmosphere in the desalter may be an inert atmosphere, for example, a nitrogen atmosphere. When the above conditions are satisfied, the oil-water separation efficiency may be improved.

For contents not further described in the apparatus for removing chlorine from waste plastic pyrolysis oil, the contents described in the method for purifying chlorine from waste plastic pyrolysis oil described above may be used for reference.

Hereinafter, the embodiments of the present disclosure will be described in detail with reference to Examples. However, these Examples are intended to describe the embodiments of the present disclosure in more detail, and the scope of the present disclosure is not limited by the following Examples.

### Example 1

Waste plastics were pyrolyzed to prepare 1,000 g of a waste plastic pyrolysis oil raw material.

The content (ppm) of each of the total chlorine, organic chlorine, and inorganic chlorine in the waste plastic pyrolysis oil raw material was measured through ICP and XRF analysis. The results are shown in Table 1.

TABLE 1

| | Waste plastic |
|---|---|
| | pyrolysis oil |
| | raw material |
| Total chlorine | 560 |
| (ppm) | |
| Organic chlorine (ppm) | 396 |
| Inorganic chlorine | 164 |
| (ppm) | |

1.21 g of a NaOC₂H₅ neutralizer and 20 g of an ethanol solvent were added to a mixer, and stirring was performed, thereby preparing a neutralizing solution. The waste plastic pyrolysis oil and the neutralizing solution were added to a continuous fixed bed reactor filled with silica beads having an average particle size of 1 mm (SSD-5003, Bangs Laboratories, Inc.), and a reaction was performed in a nitrogen atmosphere under the conditions shown in Table 2.

TABLE 2

| | Reactor |
|---|---|
| Temperature (° C.) | 350 |
| Pressure (bar) | 30 |
| Liquid hourly space | 5 |
| velocity (h⁻¹) | |
| N₂/Oil ratio | 1,000 |

A fluid generated after the reaction and 200 g of washing water were added to a desalter, and a water treatment process was performed in a nitrogen atmosphere under conditions of 90° C. and 5 bar. Finally, waste plastic pyrolysis oil with impurities reduced through the water treatment process was obtained.

### Example 2

Waste plastic pyrolysis oil with reduced impurities was obtained by performing a reaction under the same conditions as those of Example 1, except that the reaction was performed at a reactor temperature of 380° C., a desalter temperature of 150° C., and a pressure of 15 bar.

### Example 3

Waste plastic pyrolysis oil with reduced impurities was obtained by performing a reaction under the same conditions as those of Example 1, except that NaOCH₃ was used as a neutralizer and dipropylene glycol was used as a solvent.

### Example 4

Waste plastic pyrolysis oil with reduced impurities was obtained by performing a reaction under the same conditions as those of Example 1, except that 1.21 g of a NaOC₂H₅ neutralizer and 20 g of an ethanol solvent were added to a mixer, and then 100 g of water was introduced in parallel into a distal end of a reaction unit.

### Example 5

Waste plastic pyrolysis oil with reduced impurities was obtained by performing a reaction under the same conditions as those of Example 4, except that the reaction was performed at a reactor temperature of 380° C., a desalter temperature of 150° C., and a pressure of 15 bar.

### Comparative Example 1

Waste plastic pyrolysis oil with reduced impurities was obtained by performing a reaction under the same conditions as those of Example 1, except that the reaction was performed at a reactor temperature of 250° C.

### Comparative Example 2

Waste plastic pyrolysis oil with reduced impurities was obtained by performing a reaction under the same conditions as those of Example 4, except that the reaction was performed at a reactor temperature of 250° C.

### Comparative Example 3

Waste plastic pyrolysis oil with reduced impurities was obtained by performing a reaction under the same conditions as those of Example 1, except that the solvent was not used.

### Comparative Example 4

Waste plastic pyrolysis oil with reduced impurities was obtained by performing a reaction under the same conditions as those of Example 1, except that glycerol was used as a solvent.

### Comparative Example 5

Waste plastic pyrolysis oil with reduced impurities was obtained by performing a reaction under the same conditions as those of Example 1, except that NaOH was used as a neutralizer.

### Evaluation Examples

### Chlorine Content

The content (ppm) of each of the total chlorine, organic chlorine, and inorganic chlorine in the obtained waste plastic pyrolysis oil was measured through ICP and XRF analysis.

### Corrosion Effect

The corrosion effect was evaluated by introducing a specimen into the reactor and confirming whether the specimen was corroded. Specifically, a small specimen formed of the same material as that of the reactor was introduced below the catalyst layer in the reactor, and an operation was performed. While an experiment was conducted according to operation conditions, the catalyst and the specimen were recovered from the reactor after operation, and a surface of the specimen was confirmed by image analysis. A Hastelloy material was used as a material of the reactor, and a Hastelloy specimen was additionally introduced below the catalyst layer.

### Maximum Operation Time

The maximum operation time was measured as follows. A hydrotreating process was performed on the waste plastic pyrolysis oil obtained through each of Examples 1 to 5 and Comparative Examples 1 to 5. Specifically, the obtained waste plastic pyrolysis oil and hydrogen gas were added to a reactor for hydrotreating, and hydrotreating was performed in the presence of a NiMoS/γ-Al2O3 hydrotreating catalyst at 350° C. and 60 bar. The maximum operation time required until a pressure loss (delta P) due to the ammonium salt (NH₄Cl) produced during the hydrotreating process reached 7 bar was measured.

The measured results are shown in Table 3.

TABLE 3

| | | | | | | | Compar- | Compar- | Compar- | Compar- | Compar- |
|---|---|---|---|---|---|---|---|---|---|---|---|
| | | Example | Example | Example | Example | Example | ative | ative | ative | ative | ative |
| | | 1 | 2 | 3 | 4 | 5 | Example 1 | Example 2 | Example 3 | Example 4 | Example 5 |
| Reactor | Neutralizer | NaOC₂H₅ | NaOC₂H₅ | NaOCH₃ | NaOC₂H₅ | NaOC₂H₅ | NaOC₂H₅ | NaOC₂H₅ | NaOC₂H₅ | NaOC₂H₅ | NaOH |
| | Solvent | Ethanol | Ethanol | Dipropylene | Ethanol + | Ethanol + | Ethanol | Ethanol + | — | Glycerol | Ethanol |
| | | | | glycol | additional | additional | | additional | | | |
| | | | | | addition | addition | | addition of | | | |
| | | | | | of water | of water | | water | | | |
| | Temperature | 350 | 380 | 350 | 350 | 380 | 250 | 250 | 350 | 350 | 350 |
| | (° C.) | | | | | | | | | | |
| Desalter | Temperature | 90 | 150 | 90 | 90 | 150 | 90 | 90 | 90 | 90 | 90 |
| | (° C.) | | | | | | | | | | |
| | Pressure | 5 | 15 | 5 | 5 | 15 | 5 | 5 | 5 | 5 | 5 |
| | (bar) | | | | | | | | | | |

| | | | | | | | | | | |
|---|---|---|---|---|---|---|---|---|---|---|
| Total chlorine₁ | 507 | 501 | 511 | 498 | 499 | 538 | 522 | 527 | 515 | 511 |
| (ppm) | | | | | | | | | | |
| Organic chlorine | 34 | 33 | 47 | 27 | 28 | 380 | 353 | 356 | 349 | 61 |
| (ppm) | | | | | | | | | | |
| Inorganic chlorine | 473 | 468 | 464 | 471 | 471 | 158 | 169 | 171 | 166 | 450 |
| (ppm) | | | | | | | | | | |
| Total chlorine₂ | 37 | 33 | 49 | 29 | 28 | 381 | 355 | 358 | 350 | 63 |
| (ppm) | | | | | | | | | | |
| Corrosion effect | X | X | X | X | X | X | X | X | X | ◯ |
| Maximum operation | >15 | >17 | >15 | >18 | >19 | <4 | <4 | <3 | <5 | <12 |
| time (day) | | | | | | | | | | |

Total chlorine₁: Total content (ppm) of chlorine in fluid generated in the reactor and water layer
Organic chlorine: Content (ppm) of organic chlorine in fluid generated in the reactor and water layer
Inorganic chlorine: Content (ppm) of inorganic chlorine in fluid generated in the reactor and water layer
Total chlorine₂: Total content (ppm) of chlorine in waste plastic pyrolysis oil obtained after water treatment process in the desalter

### Evaluation

In Examples 1 and 2, it could be confirmed that, as the waste plastic pyrolysis oil raw material having an organic chlorine content of 396 ppm has reacted with the neutralizing solution containing the NaOC₂H₅ neutralizer and the ethanol solvent in the reactor, the organic chlorine content was reduced to 35 ppm or less.

In Examples 4 and 5, the organic chlorine content was reduced to 28 ppm or less, and it could be confirmed from this that the organic chlorine removal effect was most excellent when the cosolvent containing ethanol and water was used.

In Example 3, the measured organic chlorine content was 47 ppm, and it could be confirmed that the organic chlorine removal effect was slightly reduced compared to Examples 1 and 2 because the NaOCH₃ neutralizer and the dipropylene glycol solvent were used, but the effect was excellent compared to Comparative Examples 1 to 5.

In addition, in all of the Examples 1 to 5, it could be confirmed that inorganic chlorine was also effectively removed while the waste plastic pyrolysis oil passed through the desalter, and thus the total chlorine₂ content in the finally obtained pyrolysis oil was significantly reduced.

On the other hand, in Comparative Examples 1 and 2, it could be confirmed that as the reaction was performed at 250° C., the organic chlorine in the pyrolysis oil was not converted into HCl, and thus the organic chlorine content was about 350 ppm or more, which showed that the organic chlorine content was hardly reduced.

In Comparative Example 3, it could be confirmed that as only the neutralizer was used without a solvent, aggregation occurred and the neutralizing solution was not easily mixed with the pyrolysis oil, and thus the organic chlorine content was 356 ppm, which showed that the organic chlorine content was hardly reduced. In addition, it could be confirmed that del P occurred due to low solubility of the neutralizer, and thus the stable operation was not implemented.

Even in Comparative Example 4, it could be confirmed that the neutralizing solution was not easily mixed with the pyrolysis oil due to a high density of the glycerol solvent, and thus the organic chlorine content was 349 ppm, which showed that the organic chlorine content was hardly reduced. In addition, it could be confirmed that del P occurred during operation, and thus the stable operation was not implemented.

In all of Examples 1 to 5, it could be confirmed that the maximum operation time was 15 days or longer, which showed that the operation was performed for a long period of time. It is considered that this is because the total chlorine content in the waste plastic pyrolysis oil is reduced, and thus formation of an ammonium salt (NH₄Cl) may be suppressed. On the other hand, in Comparative Examples 1 to 4, it could be confirmed that the total chlorine content in the pyrolysis oil was large, and thus the maximum operation time was 5 days or shorter, which was significantly shorter.

When it was confirmed whether Cl-stress occurred on the surface of the specimen after 30 days of operation of the reactor in Examples 1 to 5, no cracks or pinholes caused by Cl were confirmed. Therefore, it was confirmed that there was no corrosion effect even after a long-term operation for 30 days or longer. On the other hand, in Comparative Example 5, corrosion caused by alkali occurred on the surface of the specimen after about 12 days of operation of the reactor, and it was confirmed that the NaOH neutralizer caused corrosion of the reactor.

Although embodiments of the present disclosure have been described, the present disclosure is not limited to the embodiments, but may be prepared in various different forms. It will be apparent to those skilled in the art to which the present disclosure pertains that the embodiments may be implemented in other specific forms without departing from the spirit or essential features of the present disclosure. Therefore, it is to be understood that the embodiments described hereinabove are illustrative rather than being restrictive in all aspects. Furthermore, the embodiments may be combined to form additional embodiments.

1. A method for removing chlorine from waste plastic pyrolysis oil, the method comprising:
(S1) mixing and reacting waste plastic pyrolysis oil with a neutralizing solution that contains a neutralizer containing M-OR₁ and a solvent; and
(S2) subjecting a fluid generated in the operation (S1) to a water treatment to remove chlorine,
wherein M is an alkali metal or an alkaline earth metal, and R₁ is a C₁ to C₁₀ alkyl group.

2. The method of claim 1, wherein the operation (S1) is performed at a temperature of 300 to 500° C.

3. The method of claim 1, wherein in the operation (S1), M-OR₁ contains Na—OR₂, where R₂ is a C₁ to C₄ alkyl group.

4. The method of claim 1, wherein in operation (S1), the solvent contains an alcohol.

5. The method of claim 4, wherein the alcohol has a molecular weight of 25 to 800 g/mol and a density of 0.5 to 1.1 g/cm³.

6. The method of claim 4, wherein a difference in density between the waste plastic pyrolysis oil and the alcohol is 0.3 g/cm³ or less.

7. The method of claim 4, wherein the solvent further contains water.

8. The method of claim 1, wherein in the operation (S1), an inorganic bead catalyst is added to a batch reactor together with the waste plastic pyrolysis oil and the neutralizing solution to perform a reaction.

9. The method of claim 1, wherein the operation (S1) is performed by passing the waste plastic pyrolysis oil and the neutralizing solution through a fixed bed reactor filled with an inorganic bead catalyst.

10. The method of claim 1, wherein the operation (S2) is performed at 30 to 250° C. and 2 to 50 bar.

11. The method of claim 1, wherein the operation (S2) is performed by supplying washing water to the fluid generated in the operation (S1), washing the fluid with water, and discharging an aqueous solution containing chlorine.

12. The method of claim 1, wherein 90% or more of the chlorine in the waste plastic pyrolysis oil is removed through the operation (S1) and (S2).

13. An apparatus for removing chlorine from waste plastic pyrolysis oil, the apparatus comprising:
a mixer into which a neutralizer containing M-OR₁ and a solvent are introduced and in which the neutralizer containing M-OR₁ and the solvent are mixed with each other to generate a neutralizing solution;
a reactor into which the neutralizing solution generated in the mixer and waste plastic pyrolysis oil are introduced and in which the neutralizing solution and the waste plastic pyrolysis oil react with each other; and
a desalter into which a fluid generated in the reactor and washing water are introduced, in which impurities in the fluid are washed with water, and from which an aqueous solution containing chlorine is discharged,
wherein M is an alkali metal or an alkaline earth metal, and R₁ is a C₁ to C₁₀ alkyl group.

14. The apparatus of claim 13, wherein a temperature of the reactor is 300 to 500° C.

15. The apparatus of claim 13, wherein the reactor is a batch reactor, and an inorganic bead catalyst is introduced into the reactor.

16. The apparatus of claim 13, wherein the reactor is a fixed bed reactor filled with an inorganic bead catalyst.

17. The apparatus of claim 13, wherein the desalter further includes an electric field application unit.

18. The apparatus of claim 13, wherein the desalter further includes a plurality of outlets, and the outlet further includes a density profiler.

19. The apparatus of claim 13, wherein a temperature of the desalter is 30 to 250° C., and a pressure of the desalter is 2 to 50 bar.
